(19) United States
(12) Patent Application Publication
(10) Pub. No.: US 2026/0217241 A1
(43) Pub. Date: Jul. 30, 2026

(54) CONTROL DEVICE, CONTROL METHOD, AND STORAGE MEDIUM

(71) Applicant: HONDA MOTOR CO., LTD., Tokyo (JP)

(72) Inventor: Kazuya KOBAYASHI, Tokyo (JP)

(73) Assignee: HONDA MOTOR CO., LTD., Tokyo (JP)

(21) Appl. No.: 19/453,566

(22) Filed: Jan. 20, 2026

(30) Foreign Application Priority Data
Jan. 24, 2025 (JP) 2025-010332

(51) Int. Cl. B60W 30/06; B60W 10/04; B60W 10/18; B60W 50/14; B60W 60/00

(52) U.S. Cl. CPC B60W 30/06; B60W 10/04; B60W 10/18; B60W 50/14; B60W 60/001; B60W 2510/202; B60W 2510/205; B60W 2520/10; B60W 2710/18

(57) ABSTRACT

A control device includes circuitry configured to: acquire a torque which acts on a rotation shaft of a steering unit of a vehicle, and a steering angle which is a rotation angle of the rotation shaft; determine whether there is a non-steering operation of the steering unit based on the torque and the acquired steering angle; and control a predetermined control apparatus mounted on the vehicle based on a result of determination. When the non-steering operation is detected, in response to a response to a response request to a user based on a function of the control apparatus based on the determination result, the circuitry executes a control of the control apparatus corresponding to the response request, and when the non-steering operation is not detected, the circuitry does not execute the control of the control apparatus corresponding to the response request.

### CROSS-REFERENCE TO RELATED APPLICATIONS

This application is based on and claims priority under 35 USC 119 from Japanese Patent Application No. 2025-010332 filed on January 24, 2025, the contents of which are incorporated herein by reference.

### TECHNICAL FIELD

The present disclosure relates to a control device, a control method, and a storage medium.

### BACKGROUND

In recent years, active efforts have been made to provide access to a sustainable transportation system in consideration of vulnerable traffic participants. As one of these efforts, research and development on driving assistance techniques and autonomous driving techniques for vehicles such as automobiles have been made in order to further improve safety and convenience of traffic.

With the introduction of driving assistance technology and autonomous driving technology, the number of operation switches and the like installed in a vehicle, such as an automobile, is on the rise. In some cases, an operation switch is shared with an in-vehicle device such as a navigation system, making an operation method more complicated.

Therefore, Japanese Patent Application Laid-open Publication No. 2012-150714 (hereinafter, referred to as Patent Literature 1) discloses a device that detects a vibration generated when a driver taps a steering wheel by using a measuring unit provided at the steering wheel, and outputs a control signal corresponding to operation information for a control apparatus based on the detected vibration.

However, the device in Patent Literature 1 is provided with the measuring unit and the like for detecting the vibration generated by the operation of tapping the steering wheel, which may increase costs. Therefore, it is desirable to ensure operability and enable an operation for the functioning of the control apparatus by using the existing component without adding a new component.

The present disclosure provides a control device, a control method, and a storage medium that ensure operability and enable an operation for functioning of a control apparatus by using an existing configuration.

### SUMMARY

A first aspect of the present disclosure relates to a control device including circuitry configured to: acquire a torque which acts on a rotation shaft of a steering unit of a vehicle and is detected by a first detector that detects the torque, and a steering angle which is a rotation angle of the rotation shaft and is detected by a second detector that detects the steering angle; determine whether there is a non-steering operation of the steering unit based on the torque and the acquired steering angle; and control a predetermined control apparatus mounted on the vehicle based on a result of determination. When the non-steering operation is detected, in response to a response to a response request to a user based on a function of the control apparatus, by at least one of the first detector and the second detector based on the determination result, the circuitry executes a control of the control apparatus corresponding to the response request, and when the non-steering operation is not detected by any of the first detector and the second detector based on the determination result, the circuitry does not execute the control of the control apparatus corresponding to the response request.

A second aspect of the present disclosure relates to a control device including circuitry configured to: acquire a torque which acts on a rotation shaft of a steering unit of a vehicle and is detected by a first detector that detects the torque, and a steering angle which is a rotation angle of the rotation shaft and is detected by a second detector that detects the steering angle; determine whether there is a non-steering operation of the steering unit based on the torque and the acquired steering angle; and control a predetermined control apparatus mounted on the vehicle based on a result of determination. When the non-steering operation is detected, in response to a response request from a user based on a function of the control apparatus, by at least one of the first detector and the second detector based on the determination result, the circuitry executes a control of the control apparatus corresponding to the response request, and when the non-steering operation is not detected by any of the first detector and the second detector based on the determination result, the circuitry does not execute the control of the control apparatus corresponding to the response request.

A third aspect of the present disclosure relates to a control method performed by a computer, the control method including: acquiring a torque which acts on a rotation shaft of a steering unit of a vehicle and is detected by a first detector that detects the torque, and a steering angle which is a rotation angle of the rotation shaft and is detected by a second detector that detects the steering angle; determining whether there is a non-steering operation of the steering unit based on the acquired torque and the acquired steering angle; controlling a predetermined control apparatus mounted on the vehicle based on a determination result; executing a control of the control apparatus corresponding to a response request, when the non-steering operation is detected, in response to the response request to a user based on a function of the control apparatus, by at least one of the first detector and the second detector based on the determination result; and not executing the control of the control apparatus corresponding to the response request if the non-steering operation is not detected by any of the first detector and the second detector based on the determination result.

A fourth aspect of the present disclosure relates to a non-transitory computer-readable storage medium storing a control program that causes a computer to execute a process, the process including: acquiring a torque which acts on a rotation shaft of a steering unit of a vehicle and is detected by a first detector that detects the torque, and a steering angle which is a rotation angle of the rotation shaft and is detected by a second detector that detects the steering angle; determining whether there is a non-steering operation of the steering unit based on the acquired torque and the acquired steering angle; controlling a predetermined control apparatus mounted on the vehicle based on a determination result; executing a control of the control apparatus corresponding to a response request, when the non-steering operation is detected, in response to the response request to a user based on a function of the control apparatus, by at least one of the first detector and the second detector based on the determination result; and not executing the control of the control apparatus corresponding to the response request if the non-steering operation is not detected by any of the first detector and the second detector based on the determination result.

According to the present disclosure, it is possible to ensure operability and enable an operation for functioning of a control apparatus by using an existing configuration. This further improves safety of traffic and contributes to development of a sustainable transportation system.

### BRIEF DESCRIPTION OF DRAWINGS

Exemplary embodiments of the present invention will be described in detail based on the following figures, wherein:

FIG. 1 is a block diagram showing a schematic configuration of a vehicle 1 equipped with a control device 30 according to an embodiment;

FIG. 2 is a diagram for illustrating an example of a detection value of a steering angle sensor 41;

FIG. 3 is a diagram for illustrating an example of a detection value of a torque sensor 42;

FIG. 4 is a diagram for illustrating an example of preventing an erroneous detection or erroneous determination of a non-steering operation;

FIG. 5 is a flowchart showing an example of processes executed in an embodiment; and

FIG. 6 is a subroutine for illustrating a non-steering operation determination process in step S4 in the flowchart of FIG. 5.

### DESCRIPTION OF EMBODIMENTS

Hereinafter, an embodiment will be described with reference to the accompanying drawings. The following embodiment does not limit the present disclosure, and not all of elements described in the following embodiment are necessary to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Vehicle Equipped with Control Device

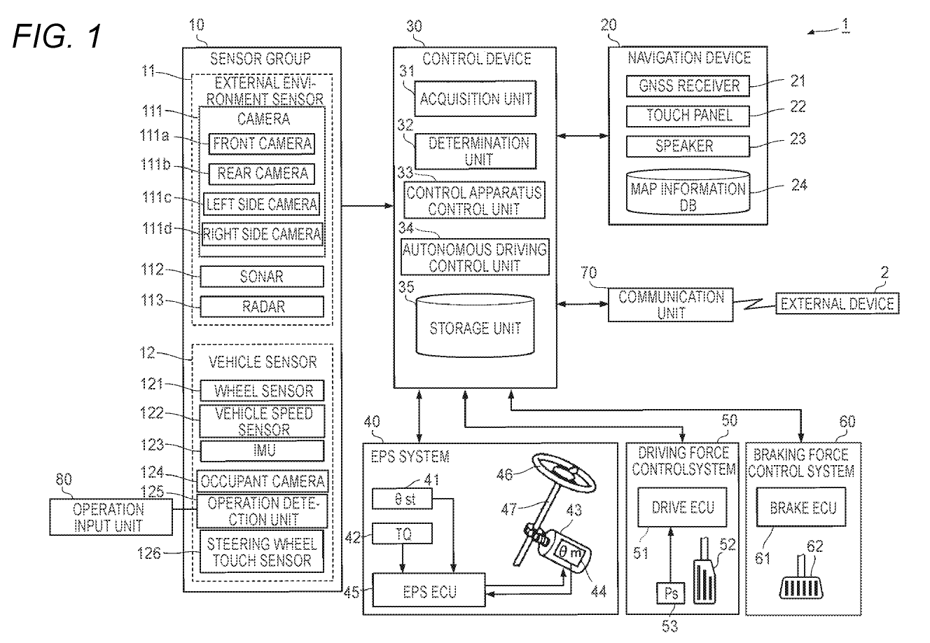

First, a configuration of a vehicle 1 equipped with a control device 30 of an embodiment will be described. FIG. 1 is a block diagram showing a configuration of the vehicle 1. The vehicle 1 is an automobile including a drive source (not shown) and wheels including drive wheels driven by power of the drive source and steerable steered wheels. As an example, the vehicle 1 can be a four-wheeled automobile including a pair of left and right front wheels and a pair of left and right rear wheels.

The drive source of the vehicle 1 may be an electric motor, may be an internal combustion engine such as a gasoline engine or a diesel engine, or may be a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

In the vehicle 1, in addition to manual driving, autonomous driving and driving assistance in which a driving operation is autonomously controlled to cause the vehicle 1 to travel are possible. The autonomous driving defined here means that a system of a vehicle performs all driving operations such as recognition or monitoring of a travel environment and peripheral situations, as well as starting, accelerating/decelerating, steering, and stopping. The driving assistance means that a system of a vehicle performs some of driving operations such as starting, accelerating/decelerating, steering, and stopping, and is, for example, an automatic parking system (APS), a lane keep assist system (LKAS), and adaptive cruise control (ACC). As is well-known in the related art, a plurality of levels of a driving control in the autonomous driving and the driving assistance may be present, and may be defined, for example, as a level 0 to a level 5 established by the Society of Automotive Engineers (SAE) of the United States. Regarding the level of the driving control, the larger the level number, the lighter an operational burden of a user such as a driver (hereinafter, referred to as the user) (in other words, the larger the level number, the higher the degree of automation). Specific contents of the level 0 to the level 5 are well known, and thus descriptions thereof are omitted here.

The vehicle 1 includes a sensor group 10, a navigation device 20, the control device 30, an electric power steering (EPS) system 40, a driving force control system 50, a braking force control system 60, a communication unit 70, and an operation input unit 80.

The sensor group 10 includes an external environment sensor 11 that acquires information about the periphery of the vehicle 1, and a vehicle sensor 12 that acquires information about the vehicle 1. Information (in other words, detection values) acquired by respective sensors included in the sensor group 10 is output to the control device 30.

The external environment sensor 11 includes, for example, a camera 111, a sonar 112, and a radar 113. The camera 111 is a digital camera that images the periphery of the vehicle 1, and outputs image data of the obtained peripheral image to the control device 30. In the present embodiment, since the vehicle 1 is capable of autonomous driving or the like, the vehicle 1 has a front camera 111a, a rear camera 111b, a left side camera 111c, and a right side camera 111d in order to acquire peripheral images in all directions of the vehicle 1. The camera 111 does not need to have all of these cameras 111a to 111d, but it is sufficient to have at least enough cameras to enable the autonomous driving, automatic parking, or the like.

The front camera 111a is provided, for example, at an upper portion of a front window in a passenger compartment or a front bumper, and images a front region of the vehicle 1. The rear camera 111b is provided, for example, at a rear bumper, and images a rear region of the vehicle 1. The left side camera 111c is provided, for example, at a left side mirror, and images a left side region of the vehicle 1. The right side camera 111d is provided, for example, at a right side mirror, and images a right side region of the vehicle 1. Each of the cameras 111a to 111d may be a digital camera using an imaging element such as a charge coupled device (CCD) or a complementary metal oxide semiconductor (CMOS). In the following description, the front camera 111a, the rear camera 111b, the left side camera 111c, and the right side camera 111d will be simply referred to as the "camera 111" unless these cameras are particularly distinguished from one another.

The sonar 112 emits sound waves to the periphery of the vehicle 1 (for example, a front side, a rear side, and lateral sides of the vehicle 1), and receives reflected sounds from an object present in the periphery of the vehicle 1, thereby detecting a distance to the object, a direction of the object, and the like. The detected information is transmitted to the control device 30 at a predetermined cycle. The radar 113 emits radio waves to the periphery of the vehicle 1 including the front side of the vehicle 1, and receives reflected waves from an object present in the periphery of the vehicle 1, thereby detecting a distance to the object, a direction of the object, and the like. The detected information is transmitted to the control device 30 at a predetermined cycle. As the radar 113, for example, a millimeter wave radar can be adopted.

The external environment sensor 11 may include a light detection and ranging (LiDAR) instead of or in addition to the sonar 112 and the radar 113. In this case, the LiDAR emits a laser light to the periphery of the vehicle 1 which includes the front of the vehicle 1, and receives the reflected light from an object present in the periphery of the vehicle 1 to detect a distance to the object, a direction of the object, and the like.

The vehicle sensor 12 includes, for example, a wheel sensor 121, a vehicle speed sensor 122, an inertial measurement unit (IMU) 123, an occupant camera 124, an operation detection unit 125, and a steering wheel touch sensor 126.

The wheel sensor 121 detects a rotation angle of one or more wheels among the wheels of the vehicle 1. As the wheel sensor 121, for example, an angle sensor or a displacement sensor can be adopted.

The vehicle speed sensor 122 detects a vehicle speed, which is a travel speed of the vehicle 1 (in other words, a movement speed of a vehicle body). For example, the vehicle speed sensor 122 detects the vehicle speed based on the number of revolutions of a countershaft (not shown) included in the vehicle 1.

The inertial measurement unit 123 detects angular velocities in a pitch direction, a roll direction, and a yaw direction of the vehicle 1, and accelerations in a front-rear direction, a left-right direction, and an upper-lower direction of the vehicle 1. The vehicle sensor 12 may include, instead of the inertial measurement unit 123, an acceleration sensor that detects an acceleration in a predetermined direction of the vehicle 1 and a gyro sensor that detects an angular velocity in a predetermined direction of the vehicle 1.

The occupant camera 124 is a digital camera that images an interior of the vehicle 1 and outputs image data of the obtained interior image to the control device 30. For example, the occupant camera 124 can be a "driver monitor camera" that is provided to be able to image a head of a user sitting in a driver seat of the vehicle 1 from the front (in other words, to image a face). As the occupant camera 124, a digital camera using an imaging element such as the CCD or the CMOS can be adopted, similarly to the camera 111. In the embodiment, the image data of the vehicle interior image obtained by the occupant camera 124 imaging the vehicle interior is information that can specify an orientation of a line of sight of the user.

The operation detection unit 125 detects an operation performed by using the operation input unit 80 that is operable by an occupant. In the embodiment, the operation input unit 80 includes, for example, an operation switch (not shown) that accepts an operation to switch the autonomous driving or automatic parking on (in other words, to be activated) and off (in other words, to be deactivated). In this case, the operation detection unit 125 can detect the operation to turn the autonomous driving or automatic parking on or off.

The steering wheel touch sensor 126 detects whether a steering wheel 46 of the vehicle 1 is being held properly. For example, the steering wheel touch sensor 126 is implemented by a capacitance sensor or the like. In this case, the capacitance sensor is provided at a portion touched by the user when the steering 46 is being held appropriately.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (map information DB) 24 and the like.

The GNSS receiver 21 identifies a current position of the vehicle 1 (for example, a latitude and longitude of a point where the vehicle 1 is located) based on a signal received from a GNSS satellite. The navigation device 20 may acquire, for example, a detection result of the vehicle sensor 12 (for example, the wheel sensor 121 or the vehicle speed sensor 122) via the control device 30, and identify or complement the current position of the vehicle 1 by an inertial navigation system (INS) using the detection value of the vehicle sensor 12.

The touch panel 22 functions as an input device that receives input of various types of information for the control device 30 and as a display unit controlled by the control device 30. For example, the touch panel 22 is implemented by combining a liquid crystal display or an organic light emitting diode (OLED) with a pointing device (for example, a touch pad). The speaker 23 is configured to output a sound to the occupant of the vehicle 1.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route. Further, the navigation device 20 may cause the touch panel 22 to perform a predetermined display according to an instruction from the control device 30. A specific display example will be described later. Further, the navigation device 20 may output, to the control device 30, predetermined information such as information indicating the identified current position of the vehicle 1 or information indicating an operation received via the touch panel 22.

The control device 30 is a computer that includes, for example, a processor for performing various calculations, a storage unit 35 having a non-transitory storage medium for storing various types of information, an input and output unit for controlling input and output of data between the inside and outside of the control device 30 (not shown), and executes overall control of the entire vehicle 1.

The control device 30 is implemented by one electronic control unit (ECU) or by a plurality of ECUs working together. A specific configuration and a specific control example of the control device 30 will be described later.

The EPS system 40 includes a steering angle sensor 41, a torque sensor 42, an EPS motor 43, a resolver 44, and an EPS ECU 45.

The steering angle sensor 41 detects a steering angle θst of the steering 46, which is a rotation angle of a steering shaft 47, and outputs information indicating the detected steering angle θst to the EPS ECU 45. The steering shaft 47 is coupled to the steering 46. That is, the steering angle sensor 41 detects the steering angle θst detected when the user operates the steering wheel 46, and outputs the detected information to the EPS ECU 45. Here, the "operation of the steering wheel 46" is not necessarily limited to a steering operation of the steering wheel 46 that steers the wheels. For example, a non-steering operation such as the user tapping or touching the steering wheel 46 is also included. In other words, the "operation" described here includes a non-steering operation that does not steer the wheels (hereinafter, simply referred to as the "non-steering operation").

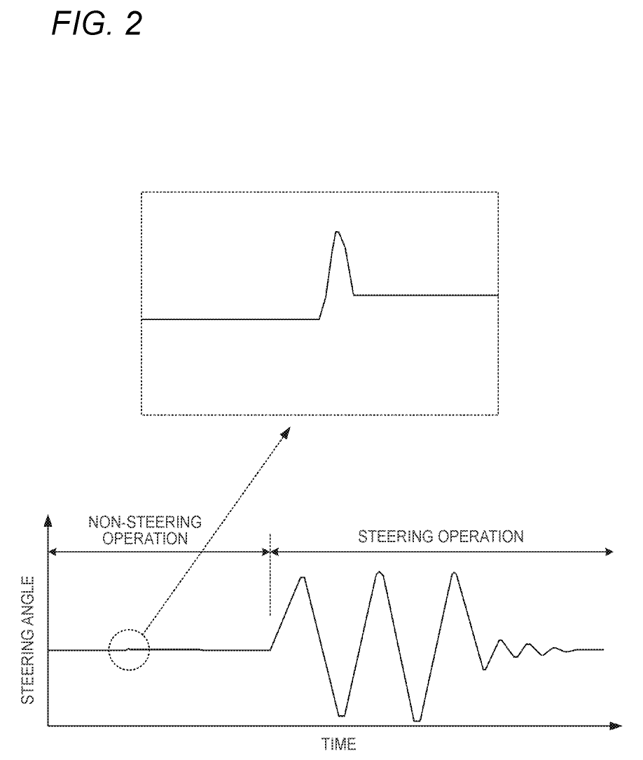

FIG. 2 is a diagram showing an example of a detection value of the steering angle sensor 41. For ease of description, the example in FIG. 2 shows that the non-steering operation, such as the user tapping the steering wheel 46, and a steering operation of steering the wheels are continuously performed. As can be known from FIG. 2, in a change in a steering angle θst of the non-steering operation and a change in a steering angle θst of the steering operation, change amounts in the changed steering angles θst are significantly different. That is, magnitude of the change in the steering angle θst in the case of the non-steering operation, surrounded by a dashed line, is clearly smaller than the change in the steering angle θst in the case of the steering operation. The change in the steering angle θst in the case of the non-steering operation is as shown in an enlarged view of the portion surrounded by the dashed line. That is, regarding the change amount in the steering angle θst per unit time, the change amount of the steering angle θst of the non-steering operation is clearly smaller than the change amount of the steering operation. Based on such a change in the steering angle θst, the control device 30 (to be described later) can determine whether the operation resulting from the change in the steering angle θst is the non-steering operation or the steering operation. That is, the operation of the user can be determined based on the detection value of the steering angle sensor 41. A detailed control example will be described later.

The non-steering operation may be implemented by operating any part of the steering wheel 46. That is, the user can implement the non-steering operation by performing an operation such as tapping any part of the steering wheel 46.

The torque sensor 42 detects a steering torque TQ, which is a torque acting on the steering shaft 47, and outputs information indicating the detected steering torque TQ to the EPS ECU 45. That is, the torque sensor 42 detects the steering torque TQ applied when the user operates the steering wheel 46, and outputs the detected information to the EPS ECU 45. Similar to the description in the steering angle sensor 41, the "operation of the steering wheel 46" described here is not necessarily limited to the steering operation of the steering wheel 46 that steers the wheels, but also includes the non-steering operation described above.

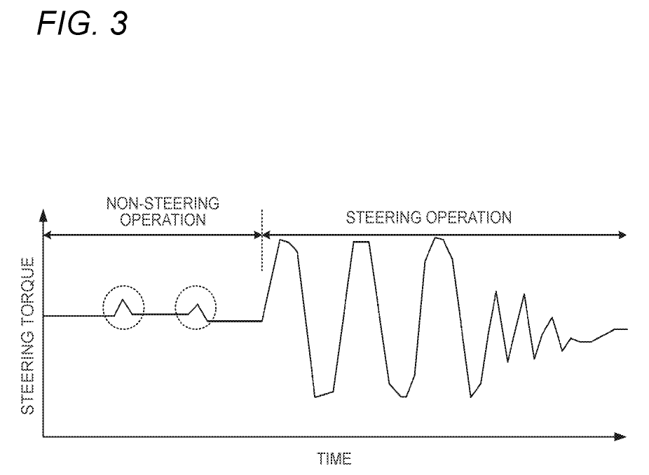

FIG. 3 is a diagram showing an example of a detection value of the torque sensor 42. For ease of description, the example shown in FIG. 3 shows that the non-steering operation, such as the user tapping the steering wheel 46, and the steering operation of steering the wheels are continuously performed. As can be known from FIG. 3, regarding a torque variation of the non-steering operation and a torque variation of the steering operation, change amounts of the torques that vary up and down are significantly different. That is, magnitude of the torque variation in the case of the non-steering operation, surrounded by a dashed line, is clearly smaller than the torque variation in the case of the steering operation. In other words, regarding a torque variation amount per unit time, the torque variation amount of the non-steering operation is clearly smaller than the torque variation amount of the steering operation. Based on such a torque variation, the control device 30 (to be described later) can determine whether the operation resulting from the torque variation is the non-steering operation or the steering operation. That is, the operation of the user can be determined based on the detection value of the torque sensor 42. A detailed control example will be described later.

In the embodiment, the steering 46 is an example of a "steering unit", the steering shaft 47 is an example of a "rotation shaft", the torque sensor 42 is an example of a "first detection unit", and the steering angle sensor 41 is an example of a "second detection unit".

The EPS motor 43 assists the user in operating the steering 46 by applying, according to an instruction from the EPS ECU 45, a driving force or a reaction force to a steering column (not shown) coupled to the steering 46. The resolver 44 detects a rotation angle θm of the EPS motor 43 and outputs information indicating the detected rotation angle θm to the EPS ECU 45.

The EPS ECU 45 is a computer that includes, for example, a processor for performing various calculations, a storage unit including a non-transitory storage medium for storing various types of information, and an input and output unit for controlling input and output of data between the inside and outside of the EPS ECU 45 (none of which are shown), and controls the EPS system 40 (for example, the EPS motor 43), and the EPS ECU 45 is implemented by one or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 may control the EPS system 40 according to an instruction from the control device 30.

The EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor for performing various calculations, a storage unit having a non-transitory storage medium for storing various type of information, and an input and output unit for controlling input and output of data between the inside and outside of the drive ECU 51 (none of which are shown), and controls the driving force control system 50, and the drive ECU 51 is implemented by one or more ECUs. For example, the drive ECU 51 controls the driving force output from the drive source of the vehicle 1 based on an amount of operation on an accelerator pedal 52 provided in the vehicle 1 and a detection value of a shift position sensor 53 that detects a shift position Ps of a shift device (for example, a shift lever or a shift switch) (not shown). As described above, the drive source is an internal combustion engine or a motor, and the drive ECU 51 controls an output of the internal combustion engine or the motor based on the amount of operation on the accelerator pedal 52 and the shift position Ps. The drive ECU 51 can also control the driving force control system 50 (for example, the drive source) according to an instruction from the control device 30.

The braking force control system 60 includes a brake ECU 61, and is configured to control a braking force of the vehicle 1. The brake ECU 61 is a computer that includes, for example, a processor for performing various calculations, a storage unit having a non-transitory storage medium for storing various types of information, and an input and output unit for controlling input and output of data between the inside and outside of the brake ECU 61 (none of which are shown), and controls the braking force control system 60, and the brake ECU 61 is implemented by one or more ECUs. For example, the brake ECU 61 controls the braking force of the vehicle 1 by controlling a brake device (not shown) provided in the vehicle 1 based on an operation on a brake pedal 62 provided in the vehicle 1. Here, the brake device includes, for example, a brake caliper, a cylinder that transmits hydraulic pressure to the brake caliper, and an electric motor that generates hydraulic pressure in the cylinder. The brake ECU 61 controls the electric motor of the brake device to generate a braking force corresponding to the operation on the brake pedal 62. The brake ECU 61 can also control the braking force control system 60 according to an instruction from the control device 30.

The communication unit 70 is a communication interface that communicates with an external device 2 according to a control instruction from the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be adopted for the communication between the vehicle 1 and the external device 2.

### Configuration of Control Device

Next, a configuration of the control device 30 will be specifically described. The control device 30 executes various programs stored in the storage unit 35. In the embodiment, the control device 30 determines whether there is the non-steering operation performed by the user in response to a response request based on a function of a control apparatus, such as the autonomous driving or automatic parking, and executes a control of the control apparatus corresponding to the response request based on the determination result. As described above, with the introduction of the autonomous driving technology and the driving assistance technology, the number of operation switches and the like provided in a vehicle is on the rise, and by sharing the operation switches with in-vehicle devices such as a navigation system, operability of the operation switches may become more complicated or cumbersome. Therefore, in the embodiment, a predetermined program is executed which ensures the operability and enables operations for the functioning of the control apparatus by using an existing component without adding a new component.

Specifically, the control device 30 includes an acquisition unit 31, a determination unit 32, and a control apparatus control unit 33 as functional units that are implemented by executing a predetermined program. In the following, processes described as being executed by the acquisition unit 31, the determination unit 32, and the control apparatus control unit 33 are processes implemented by the control device 30.

The acquisition unit 31 acquires the steering torque TQ, which is detected by the torque sensor 42 and detects the torque acting on the steering shaft 47, and the steering angle θst, which is detected by the steering angle sensor 41 for detecting the steering angle θst of the steering wheel 46. As described above, information such as the detection values acquired by the torque sensor 42 and information such as the detection values acquired by the steering angle sensor 41 are output to the control device 30. The information output to the control device 30 is then stored in the storage unit 35. Therefore, the acquisition unit 31 refers to the storage unit 35 to acquire the steering torque TQ detected by the torque sensor 42 and the steering angle θst detected by the steering angle sensor 41.

The determination unit 32 determines whether there is the non-steering operation on the steering wheel 46 based on the steering torque TQ and the steering angle θst acquired by the acquisition unit 31. For example, the determination unit 32 compares the steering torque TQ acquired by the function of the acquisition unit 31 with reference information (for example, waveform illustrated in FIG. 3) of the steering torque TQ during the non-steering operation stored in the storage unit 35 in advance to determine whether the acquired steering torque TQ represents the non-steering operation. If the determination unit 32 determines that the information of the acquired steering torque TQ matches or is similar to the reference information of the steering torque TQ, the determination unit 32 determines that the acquired steering torque TQ is based on the non-steering operation. As described above, the magnitude of the torque variations between the non-steering operation and the steering operation is clearly different as described with reference to FIG. 3, and thus, determination of the non-steering operation becomes easy, and whether there is the non-steering operation may be determined by, for example, defining the torque variation amount per unit time.

If the determination unit 32 determines that the acquired steering torque TQ does not match or is not similar to the reference information of the steering torque TQ, the determination unit 32 determines that the acquired steering torque TQ is not based on the non-steering operation.

In addition, the determination unit 32 compares the steering angle θst acquired by the function of the acquisition unit 31 with reference information (for example, waveform illustrated in FIG. 2) of the steering angle θst during the non-steering operation stored in the storage unit 35 in advance to determine whether the acquired steering angle θst represents the non-steering operation. If the determination unit 32 determines that the information of the acquired steering angle θst matches or is similar to the reference information of the steering angle θst, the determination unit 32 determines that the acquired steering angle θst is based on the non-steering operation. As described above, the magnitude of changes in the steering angles θst between the non-steering operation and the steering operation is clearly different as described with reference to FIG. 2, and thus, the determination of the non-steering operation becomes easy, and whether there is the non-steering operation may be determined by, for example, defining a change amount of the steering angles θst per unit time.

If the determination unit 32 determines that the acquired steering angle θst does not match or is not similar to the reference information of the steering angle θst, the determination unit 32 determines that the acquired steering angle θst is not based on the non-steering operation.

The control apparatus control unit 33 controls a predetermined control apparatus mounted on the vehicle 1 based on the determination result of the determination unit 32 as to whether there is the non-steering operation. Specifically, in response to the response request to the user based on the function of the control apparatus, if the non-steering operation is detected by at least one of the torque sensor 42 and the steering angle sensor 41 based on the determination result of the determination unit 32, the control apparatus control unit 33 executes control of the control apparatus corresponding to the response request. Conversely, if the non-steering operation is not detected by any of the torque sensor 42 and the steering angle sensor 41 based on the determination result of the determination unit 32, the control apparatus control unit 33 does not execute the control of the control apparatus corresponding to the response request.

Here, the "response request to the user based on the function of the control apparatus" may include, in addition to the above autonomous driving control and a driving assistance control such as ACC and APS, operations on an audio device (for example, operations of turning up and down a volume and skipping a song), a destination search operation on the navigation device 20, a search for a route to a destination, an air conditioning operation, and the like. The control and the operations based on the response requests listed here are merely examples and may be freely set by, for example, a manufacturer. The control apparatus control unit 33 issues such a response request by, for example, displaying the response request on a display unit such as the touch panel 22 or outputting the response request as audio from the speaker 23. The user can then respond to the response request by performing the non-steering operation, such as tapping the steering wheel 46.

The above response requests can be classified depending on a request content into, for example, a "response request involving a braking/driving force control" that controls the driving force and/or braking force, such as in autonomous driving or driving assistance, and a "response request not involving the braking/driving force control", such as a search for a route to a destination.

If the non-steering operation is detected by at least one of the torque sensor 42 and the steering angle sensor 41 based on the determination result of the determination unit 32, the control apparatus control unit 33 executes the control of the control apparatus corresponding to the response request. In this case, the control apparatus control unit 33 preferably sets whether to execute the control of the control apparatus corresponding to the response request depending on the content of the response request. For example, when the response request is the above response request involving the braking/driving force control, since the braking/driving force control is a control that is directly related to the travelling of the vehicle 1, it is preferable to execute the control of the control apparatus corresponding to the response request based on the determination that the non-steering operation is detected by both the torque sensor 42 and the steering angle sensor 41 in consideration of safety and the like.

For example, when the response request is driving assistance such as starting an automatic parking control (APS) for moving the vehicle 1 to a target parking position, the control apparatus control unit 33 starts to execute the control of the control apparatus for performing the automatic parking if it is determined that the non-steering operation is detected by both the torque sensor 42 and the steering angle sensor 41. That is, on a condition that the non-steering operation is detected by both the torque sensor 42 and the steering angle sensor 41, the control apparatus control unit 33 performs a driving control, a braking control, a steering control, and the like via the drive ECU 51, the brake ECU 61, the EPS ECU 45, and the like to start the automatic parking control for moving the vehicle 1 to the target parking position.

In the response request involving the braking/driving force control, such as the automatic parking control, if the non-steering operation is detected by only one of the torque sensor 42 and the steering angle sensor 41, or if the non-steering operation is not detected by either sensor, the control apparatus control unit 33 does not execute the control of the control apparatus corresponding to the response request. That is, since the non-steering operation in response to the response request involving the braking/driving force control is not detected, the control apparatus control unit 33 does not execute the control of the control apparatus corresponding to the response request.

On the other hand, for example, when the response request is the response request not involving the braking/driving force control, such as an operation of the navigation device 20, the control apparatus control unit 33 may relax the conditions as compared with that for the response request involving the braking/driving force control, and may execute the control of the control apparatus corresponding to the response request based on the determination that the non-steering operation is detected by at least one of the torque sensor 42 and the steering angle sensor 41.

For example, if the response request is to cause the navigation device 20 to start to search for a route to a destination, the control apparatus control unit 33 executes the control of the control apparatus for performing a route search if it is determined that the non-steering operation is detected by at least one of the torque sensor 42 and the steering angle sensor 41. That is, the control apparatus control unit 33 controls the navigation device 20 to start to search for the route to the destination, on the condition that the non-steering operation is detected by one of the torque sensor 42 and the steering angle sensor 41.

In the response request not involving the braking/driving force control, if the non-steering operation is not detected by any sensor of the torque sensor 42 and the steering angle sensor 41, the control apparatus control unit 33 does not execute the control of the control apparatus corresponding to the response request. That is, since the non-steering operation in response to the response request not involving the braking/driving force control is not detected, the control apparatus control unit 33 does not execute the control of the control apparatus corresponding to the response request.

In this way, in the embodiment, if a condition set depending on the content of the response request, such as the response request involving braking/driving force control or the response request not involving the braking/driving force control, is satisfied, the control of the control apparatus corresponding to the response request is executed. Note that the "condition that the non-steering operation is detected by the torque sensor 42 and the steering angle sensor 41" imposed in the case of the response request involving the braking/driving force control is an example of a "first condition" in the embodiment. In addition, the "condition that the non-steering operation is detected by at least one of the torque sensor 42 and the steering angle sensor 41" imposed in the case of the response request not involving the braking/driving force control is an example of a "second condition" in the embodiment. In the following description, these conditions are also simply referred to as the "first condition" and the "second condition".

On the other hand, responses from the user based on the above non-steering operation may result in erroneous detection or erroneous determination. For example, when the vehicle 1 is travelling, unavoidable vibrations, noise, disturbances, and the like may occur. For example, when the vehicle 1 is travelling at a predetermined vehicle speed or higher, the control device 30 may erroneously detect or erroneously determine the non-steering operation due to vibrations. When the vehicle 1 is travelling at the predetermined vehicle speed or higher, the operation of the user on the steering wheel 46 may become complicated, which may result in the erroneous detection or erroneous determination of the non-steering operation. Therefore, in the embodiment, in order to reduce or prevent such erroneous detection or erroneous determination of the non-steering operation, the determination of whether there is the non-steering operation is restricted under predetermined conditions.

Specifically, if the vehicle speed of the vehicle 1 is less than the predetermined vehicle speed, the determination unit 32 determines whether there is the non-steering operation. In other words, if the vehicle speed is equal to or greater than the predetermined vehicle speed, the determination unit 32 does not determine whether there is a non-steering operation. Note that this predetermined vehicle speed may be set in advance by experiments or the like. The vehicle speed is also obtained based on information from the vehicle speed sensor 122, for example.

If a steering speed of the wheel is less than a predetermined steering speed, the determination unit 32 determines whether there is the non-steering operation. In other words, if the steering speed is equal to or greater than the predetermined steering speed, the determination unit 32 does not determine whether there is the non-steering operation. This is because a fast steering speed may make the operation of the user complicated, potentially resulting in the erroneous detection or erroneous determination of the non-steering operation. This predetermined steering speed may be set in advance, for example, by experiments. The steering speed may be acquired, for example, based on information from a turning angle sensor (not shown) or information on the steering angle θst acquired by the steering angle sensor 41.

If the number of another detection by the torque sensor 42 is less than a predetermined number within a predetermined time before and after the detection by the torque sensor 42, the determination unit 32 determines whether there is a non-steering operation based on the detection of the torque sensor 42. In other words, if the number of other detections by the torque sensor 42 is equal to or greater than the predetermined number within the predetermined time before and after the detection by the torque sensor 42, the determination unit 32 does not determine whether there is the non-steering operation based on the detection of the torque sensor 42.

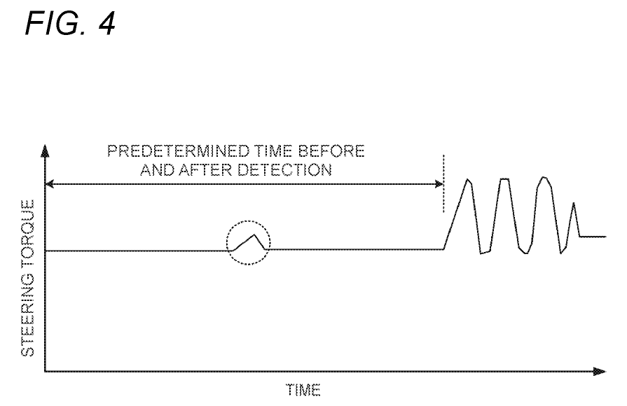

Whether to determine whether there is the non-steering operation will be described with reference to FIG. 4. For example, if a torque variation indicated by a dashed line is detected in response to the response request to the user, the determination unit 32 determines whether there is the non-steering operation if the number of other detections by the torque sensor 42 is less than the predetermined number within a predetermined time before and after the torque variation is detected. In other words, in FIG. 4, the determination unit 32 does not determine whether there is the non-steering operation based on the detection of the torque sensor 42 if the number of other detections other than the torque variation surrounded by the dashed line is equal to or greater than the predetermined number within the predetermined time before and after the detection. Note that the "predetermined time before and after the detection" is assumed to be a short time, such as one second. The "predetermined number" may be set in advance by a manufacturer or the like, and is set to a number that takes into account, for example, erroneous detection and erroneous determination.

Although the number of other detections by the torque sensor 42 is preferably "0", it is possible that the response of the user to the response request is not necessarily based on single tapping on the steering wheel 46 or the like, but rather on individual differences, such as continuous tapping or tapping on the steering wheel 46 at intervals in a short time. It is also possible that disturbances that cause unavoidable slight torque variations may occur. Therefore, the number of other detections other than the torque variation is defined here as being less than a predetermined number, including "0".

For the same purpose, the determination unit 32 determines whether there is a non-steering operation based on the detection of the steering angle sensor 41 if the number of another detection by the steering angle sensor 41 is less than a predetermined number within a predetermined time before and after the detection by the steering angle sensor 41. In other words, the determination unit 32 does not determine whether there is the non-steering operation based on the detection of the steering angle sensor 41 if the number of other detections by the steering angle sensor 41 is equal to or greater than the predetermined number within the predetermined time before and after the detection by the steering angle sensor 41. A detailed description is similar to the description of the torque sensor 42 described with reference to FIG. 4, and thus the description is omitted here.

### Flowchart

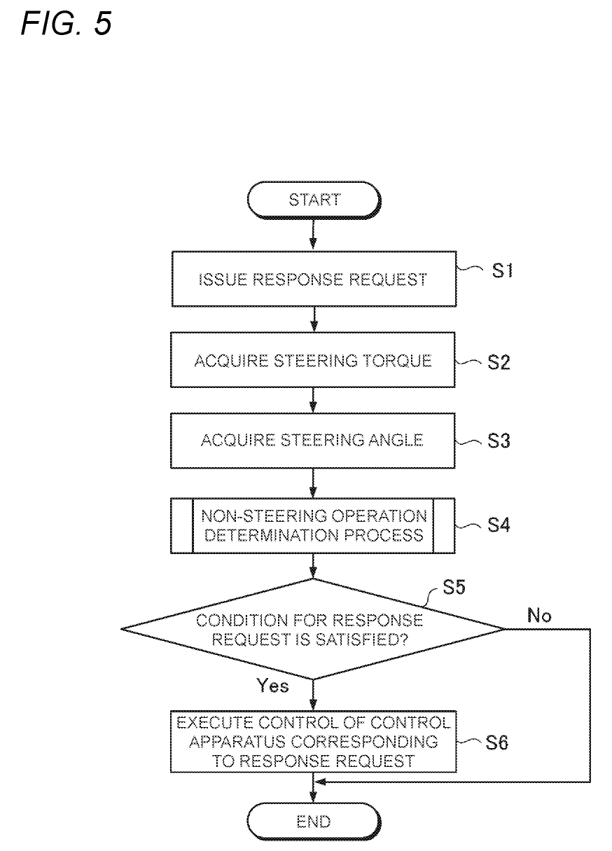

Next, an example of processing executed by the control device 30 will be described in the embodiment. FIG. 5 is a flowchart showing an example of the processing. In the example shown here, if the response from the user to the response request satisfies a predetermined condition, the control device 30 executes the control of the control apparatus corresponding to the content of the response request. Since a specific content of the processing in the control device 30 is as described above, here, the flow of the processing will be mainly described, and the detailed description of the processing will be omitted or simplified.

Note that the processing shown in FIG. 5 assumes that the vehicle speed and the steering speed, which are conditions for preventing the above erroneous detection and erroneous determination, are less than the predetermined vehicle speed and the predetermined steering speed, respectively. In the response to the response request, the detected information of the torque sensor 42 and the steering angle sensor 41 is that the number is less than a predetermined number within a predetermined time before and after the detection of the response to the response request. Furthermore, the processing shown in FIG. 5 is executed when an ignition power source is turned on.

First, in step S1, the control device 30 issues a response request. Here, as an example, the description is made assuming that a response request regarding whether to start the automatic parking control is issued. That is, the control device 30 issues, via the touch panel 22, the speaker 23, or the like, the response request regarding whether to start the automatic parking control. Note that examples of a situation where the control device 30 issues the response request of the automatic parking control to the user may include a case where the vehicle 1 enters the premises of a predetermined parking lot, such as home of the user, or a case where a distance between the vehicle 1 and the predetermined parking lot is within a predetermined distance.

Next, in step S2, the control device 30 acquires the steering torque TQ. That is, the control device 30 uses the function of the acquisition unit 31 to acquire information of the steering torque TQ based on information from the torque sensor 42.

Similarly, in step S3, the control device 30 acquires the steering angle θst. That is, the control device 30 uses the function of the acquisition unit 31 to acquire information of the steering angle θst based on the information from the steering angle sensor 41. Note that steps S2 and S3 may be performed in reverse order, or may be performed simultaneously.

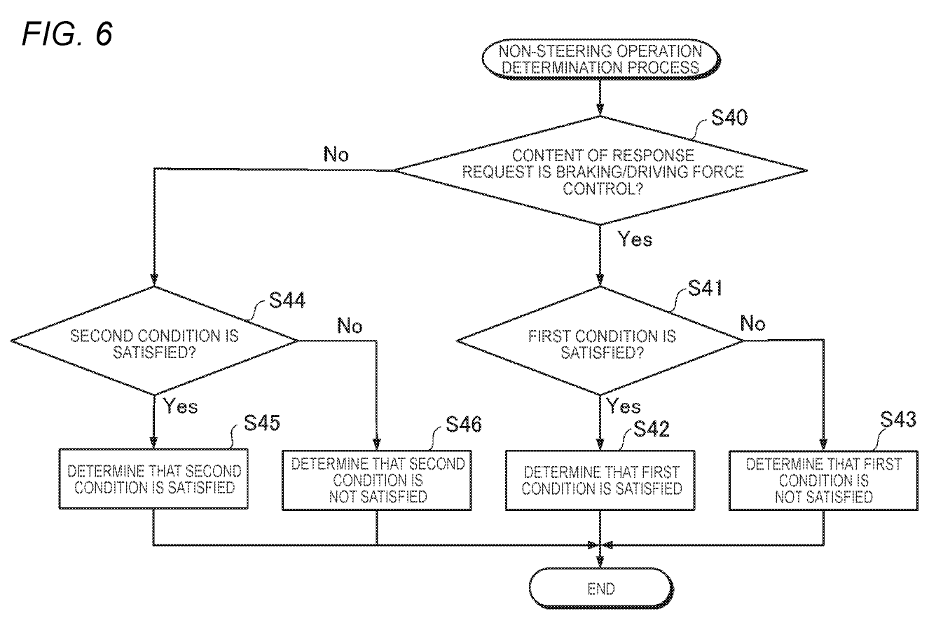

Next, the control device 30 performs a non-steering operation determination process of determining whether there is the non-steering operation performed by the user (step S4). FIG. 6 is a subroutine showing an example of the non-steering operation determination process. In the non-steering operation determination process, the control device 30 determines whether the operation performed by the user in response to the response request satisfies the condition for the non-steering operation based on the content of the response request.

First, the control device 30 determines whether the content of the response request is related to the braking/driving force control (step S40). In the example shown here, as described above, the response request regarding whether to start the automatic parking control is issued, as an example. Therefore, a positive determination is made in step S40 (Yes in step S40), and the control device 30 proceeds to step S41.

In step S41, the control device 30 uses the function of the determination unit 32 to determine whether the first condition is satisfied. As described above, the first condition is that "the non-steering operation is detected by the torque sensor 42 and the steering angle sensor 41". Specifically, the control device 30 compares the information on the steering torque TQ acquired in step S2 with the reference information on the steering torque TQ during the non-steering operation stored in the storage unit 35, and determines whether the information on the steering torque TQ matches or is similar to the reference information on the steering torque TQ.

Similarly, the control device 30 compares the information on the steering angle θst acquired in step S3 with the reference information on the steering angle θst during the non-steering operation stored in the storage unit 35, and determines whether the information on the steering angle θst matches or is similar to the reference information on the steering angle θst.

In these determination processes, if it is determined that both the steering torque TQ and the steering angle θst match or are similar to the respective pieces of the reference information stored in the storage unit 35 (Yes in step S41), the control device 30 determines that the first condition is satisfied (step S42). That is, if the information acquired based on the torque sensor 42 and the steering angle sensor 41 corresponds to the non-steering operation as described with reference to FIGS. 2 and 3, the control device 30 determines that the first condition is satisfied and regards that the user responds to the response request.

Conversely, if it is determined that the information on at least one of the steering torque TQ and the steering angle θst does not match or is not similar to the reference information stored in the storage unit 35 (No in step S41), the control device 30 determines that the first condition is not satisfied (step S43). That is, if at least one of the pieces of information acquired based on the torque sensor 42 and the steering angle sensor 41 does not correspond to the non-steering operation as described with reference to FIGS. 2 and 3, the control device 30 determines that the first condition is not satisfied and regards that the user does not respond to the response request.

Note that if the content of the response request is not related to the braking/driving force control, such as the start of the automatic parking control, a negative determination is made in step S40 (No in step S40). For example, the response request may be a request to start to search for a route to a destination in the navigation device 20. In such a case, the control device 30 proceeds to step S44.

In step S44, the control device 30 uses the function of the determination unit 32 to determine whether the second condition is satisfied. As described above, the second condition is that "the non-steering operation is detected by at least one of the torque sensor 42 and the steering angle sensor 41". Specifically, the control device 30 compares the information on the steering torque TQ acquired in step S2 with the reference information on the steering torque TQ during the non-steering operation stored in the storage unit 35, and determines whether the information on the steering torque TQ matches or is similar to the reference information on the steering torque TQ.

Similarly, the control device 30 compares the information on the steering angle θst acquired in step S3 with the reference information on the steering angle θst during the non-steering operation stored in the storage unit 35, and determines whether the information on the steering angle θst matches or is similar to the reference information on the steering angle θst.

In these determination processes, if it is determined that at least one of the steering torque TQ and the steering angle θst matches or is similar to the respective pieces of the reference information stored in the storage unit 35 (Yes in step S44), the control device 30 determines that the second condition is satisfied (step S45). That is, if at least one of the pieces of the information acquired based on the torque sensor 42 and the steering angle sensor 41 corresponds to the non-steering operation as described with reference to FIGS. 2 and 3, the control device 30 determines that the second condition is satisfied and regards that the user responds to the response request.

Conversely, if it is determined that the information on any one of the steering torque TQ and the steering angle θst does not match or is not similar to the reference information stored in the storage unit 35 (No in step S44), the control device 30 determines that the second condition is not satisfied (step S46). That is, if any one of the pieces of information acquired based on the torque sensor 42 and the steering angle sensor 41 does not correspond to the non-steering operation as described with reference to FIGS. 2 and 3, the control device 30 determines that the second condition is not satisfied and regards that the user does not respond to the response request.

After performing any of the determinations in steps S43 to S46, the control device 30 proceeds to step S5 in FIG. 5.

In step S5, the control device 30 uses the function of the determination unit 32 to determine whether the condition for the response request is satisfied. That is, the control device 30 determines whether the first condition or the second condition for the response request in step S1 is satisfied, based on the determination result of the non-steering operation determination process in step S4.

If a positive determination is made in step S5 that the condition for the response request is satisfied (Yes in step S5), the control device 30 proceeds to step S6.

In step S6, the control device 30 executes the control of the control apparatus corresponding to the response request. For example, when the content of the response request is to start the automatic parking control, the control device 30 performs a driving control, a braking control, a steering control, and the like via the drive ECU 51, the brake ECU 61, the EPS ECU 45, and the like to start the automatic parking control of moving the vehicle 1 to the target parking position. For example, when the content of the response request is to start to search for a route to a destination in the navigation device 20, the control device 30 controls the navigation device 20 to start to search for the route to the destination.

On the other hand, if a negative determination is made in step S5 that the condition for the response request is not satisfied (No in step S5), the control device 30 temporarily ends the processing shown in FIG. 5.

### Effects of Embodiment

As described above, in the embodiment, the user can respond to the response request to the user based on the function of the control apparatus, such as the automatic parking control, by performing the non-steering operation, such as tapping the steering wheel 46. That is, the user does not need to operate a dedicated operation switch or the touch panel 22 of the navigation device 20 in response to the response request from the vehicle 1, and can respond to the response request by a simple operation, such as tapping the steering wheel 46. Therefore, the operability and the marketability can be improved or ensured.

In the embodiment, whether there is the non-steering operation performed by the user is determined based on the information detected by the steering angle sensor 41 and/or the torque sensor 42 included in the EPS system 40. Therefore, for example, a new component such as a measuring unit that detects the non-steering operation of the user is not required. In other words, whether there is the non-steering operation performed by the user can be determined using the existing component. As a result, it is possible to implement a switch function with excellent operability while avoiding increases in cost.

In the embodiment, a first condition or a second condition is set depending on the content of the response request as a condition for executing the control of the control apparatus corresponding to the response request. That is, if the condition according to the content of the response request is satisfied, the control apparatus executes the control corresponding to the response request. For example, the first condition is applied to the response request involving the braking/driving force control, such as the automatic parking, and the second condition is applied to the response request not involving the braking/driving force control, such as starting to search for a route to a destination in the navigation device 20. In this way, by making the condition relatively stricter for the control related to the travelling or safety of the vehicle 1, such as the control involving the braking/driving force control, it is possible to more reliably determine whether there is the non-steering operation and to enable the control that takes the safety of the vehicle 1 into consideration.

In the embodiment, the condition for determining whether there is the non-steering operation is that the vehicle speed is less than the predetermined vehicle speed. That is, if the vehicle speed is less than the predetermined vehicle speed, whether there is the non-steering operation is determined, but if the vehicle speed is equal to or greater than the predetermined vehicle speed, whether there is the non-steering operation is not determined. Accordingly, it is possible to reduce or avoid the erroneous detection or erroneous determination of the non-steering operation due to vibrations, noise, and the like that may occur in the vehicle 1 during the travelling. As the vehicle speed increases, the operation of the user on the steering wheel 46 becomes more complicated, which may result in the erroneous detection or erroneous determination of the non-steering operation. However, by not determining whether there is the non-steering operation at the predetermined vehicle speed or higher, the possibility of the erroneous detection or erroneous determination of the non-steering operation due to such a complicated operation on the steering wheel 46 can be reduced.

In the embodiment, the condition for determining whether there is the non-steering operation is that the steering speed is less than the predetermined steering speed. That is, if the steering speed is less than the predetermined steering speed, whether there is the non-steering operation is determined, but if the steering speed is equal to or greater than the predetermined steering speed, whether there is the non-steering operation is not determined. Accordingly, it is possible to reduce or avoid the erroneous detection or erroneous determination of the non-steering operation due to vibrations, noise, and the like that may occur in the vehicle 1 during the travelling. As the steering speed increases, the operation of the user on the steering wheel 46 becomes more complicated, which may result in the erroneous detection or erroneous determination of the non-steering operation. However, by not determining whether there is the non-steering operation at the predetermined steering speed or higher, the possibility of the erroneous detection or erroneous determination of the non-steering operation due to such a complicated operation on the steering wheel 46 can be reduced.

In the embodiment, if the number of other detections by the steering angle sensor 41 within the predetermined time before and after the detection of the steering angle θst by the steering angle sensor 41 is less than the predetermined number, whether there is the non-steering operation is determined. In other words, if the number of other detections by the steering angle sensor 41 is equal to or greater than the predetermined number, whether there is the non-steering operation is not determined. This is because there is a risk that the accuracy of determining whether there is the non-steering operation may decrease if there are many other detections (that is, other operations) by the steering angle sensor 41. That is, if the number of detections by the steering angle sensor 41 is equal to or greater than the predetermined number, it becomes difficult to distinguish whether the response is for the response request. Therefore, by excluding the case where the number of other detections by the steering angle sensor 41 is equal to or greater than the predetermined number within the predetermined time before and after the detection, it is possible to prevent a decrease in the accuracy of determining whether there is the non-steering operation.

Similarly, if the number of other detections by the torque sensor 42 within the predetermined time before and after the detection of the steering torque TQ by the torque sensor 42 is less than the predetermined number, whether there is the non-steering operation is determined. In other words, if the number of other detections by the torque sensor 42 is equal to or greater than the predetermined number, whether there is the non-steering operation is not determined. This is because there is a risk that the accuracy of determining whether there is the non-steering operation may decrease if there are many other detections (that is, other operations) by the torque sensor 42. That is, if the number of detections by the torque sensor 42 is equal to or greater than the predetermined number, it becomes difficult to distinguish whether the response is for the response request. Therefore, by excluding the case where the number of other detections by the torque sensor 42 within the predetermined time before and after the detection is equal to or greater than the predetermined number, it is possible to prevent a decrease in the accuracy of determining whether there is the non-steering operation.

### Modification

Next, a modification will be described. In the above embodiment, an example has been described in which the user responds to the response request from the vehicle 1 by performing the non-steering operation on the steering wheel 46. However, it is also possible to assume a case where the user wants to make a negative response to the response request from the vehicle 1 (for example, starting the automatic parking control), such as parking the vehicle by his/her own operation. That is, in the above embodiment, the positive response to the response request from the vehicle 1 is substantially performed through the non-steering operation, but the negative response is also possible. In such a case, it is preferable to change specifications and settings of the non-steering operation for the positive response and the negative response. That is, it is preferable to be able to perform a response by the non-steering operation on the steering wheel 46.

For example, the information from the steering angle sensor 41 and the torque sensor 42 obtained when the steering wheel 46 is tapped once is stored in the storage unit 35 as the "positive response". Similarly, the information from the steering angle sensor 41 and the torque sensor 42 obtained when the steering wheel 46 is tapped twice is stored in the storage unit 35 as the "negative response". In response to the response request, the information from the steering angle sensor 41 and the torque sensor 42 obtained by the operation of the user is compared with the information stored in the storage unit 35, and if the information matches or is similar to the information obtained by, for example, tapping once, it is determined that the positive response is obtained, and if the information matches or is similar to the information obtained by tapping twice, it is determined that the negative response is obtained. If the positive response is obtained, the control device 30 starts the control of the control apparatus corresponding to the response request.

Such a specification and setting are merely an example, and for example, the response to the response request may be determined based on a waveform or amplitude obtained by, for example, long-pressing the steering wheel 46. Furthermore, for example, a relationship between the "positive response" and the "negative response" described above may be reversed. That is, the information from the steering angle sensor 41 and the torque sensor 42 obtained by tapping the steering wheel 46 once may be stored in the storage unit 35 as the "negative response", and the information from the steering angle sensor 41 and the torque sensor 42 obtained by tapping the steering wheel 46 twice may be stored in the storage unit 35 as the "positive response". Then, for the response request, the information from the steering angle sensor 41 and the torque sensor 42 obtained by the operation of the user may be compared with the information stored in the storage unit 35 to determine the response.

In this way, the user can perform the positive response and the negative response to the response request from the vehicle 1 by the non-steering operation on the steering wheel 46. As a result, for example, compared to a configuration in which only the positive response is possible, the operability is improved, and the inconvenience of only being able to make the positive response can be reduced.

In the above embodiment, an example has been described in which in order to prevent the erroneous detection or erroneous determination of the non-steering operation, the determination unit 32 does not determine whether there is the non-steering operation if the vehicle speed is equal to or greater than the predetermined vehicle speed or if the steering speed is equal to or greater than the predetermined steering speed, but in a situation where the occurrence of such erroneous detection or erroneous determination can be assumed, a configuration may be adopted in which the response request from the vehicle 1 is not issued.

In the above embodiment, an example has been described in which the response request is issued from the vehicle 1 and the user responds to this response request through the non-steering operation. However, for example, for some of response requests not involving the braking/driving force control, as a specification in which a response request is always issued while the control apparatus corresponding to the response request is functioning, a setting of being able to respond the response request even if the response request is not displayed on a display unit of the touch panel 22 or the like my be made. For example, a setting may be made in which when an audio function is functioning, an operation such as changing the volume or skipping the currently playing song can be responded to even when the response request is not displayed. Accordingly, the convenience for response requests not involving the braking/driving force control can be improved. Since the response requests involving the braking/driving force control are response requests related to travelling, a configuration is preferably made in which a response request is issued from the vehicle 1 each time and the user responds to this response request.

A range of the steering wheel 46 that performs the non-steering operation may be set depending on the function. For example, in the case of the above positive response or an action associated with a positive response, such as turning up the volume, a setting may be made such that a response can be made by performing the non-steering operation on a right half of the steering wheel 46. Similarly, in the case of the negative response or an action associated with a negative response, such as turning down the volume, a setting may be made such that a response can be made by performing the non-steering operation on a left half of the steering wheel 46.

In the above embodiment, a case where the vehicle 1 enters an area of a parking lot has been described as an example of the trigger for performing the response request of starting the automatic parking control, but the trigger for the response request may be defined depending on the content of the response request. For example, in the case of the autonomous driving control, the response request may be issued when a destination is set in the navigation device 20.

In the above embodiment, an example has been described in which the response request is displayed on the display unit or the like of the touch panel 22 of the navigation device 20, but the display unit may be a display that also displays a speedometer or the like.

Furthermore, in the above embodiment, the response request is a response request from the vehicle 1 to the user, but the response request is not limited to a response request from the vehicle 1, and may be issued from the user. For example, when the user requests the start of the automatic parking control, the user performs the non-steering operation, such as tapping the steering wheel 46, so that a system for performing the automatic parking control may operate. In this case, similar to the response request from the vehicle 1, the automatic parking control is the response request involving the braking/driving force control, and thus the first condition that the non-steering operation is detected by the torque sensor 42 and the steering angle sensor 41 is set as a condition. Then, if the first condition is satisfied, the control of the control apparatus related to the automatic parking control corresponding to the response request is executed.

When the response request from the user is a response request not involving the braking/driving force control, if the non-steering operation is detected by at least one of the torque sensor 42 and the steering angle sensor 41, the control of the control apparatus corresponding to the response request is executed. Other requirements and conditions may be similar to those in the above example of the response request from the vehicle 1. Therefore, the description thereof will be omitted here.

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure. In addition, respective constituent elements in the above embodiment may be freely combined without departing from the gist of the disclosure.

For example, at least a part of units (the acquisition unit 31, the determination unit 32, and the control apparatus control unit 33) constituting the control device 30 may be separated and present in a plurality of devices.

Further, a part of the configurations of the above embodiment may be omitted, or the processing may be changed or omitted.

The processing described in the above embodiment can be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present description, at least the following matters are described. Although corresponding constituent elements in the embodiment described above are shown in parentheses, the present disclosure is not limited thereto.

(1) A control device (control device 30) including

an acquisition unit (acquisition unit 31) configured to acquire a torque (steering torque TQ) which acts on a rotation shaft (steering shaft 47) of a steering unit (steering wheel 46) of a vehicle (vehicle 1) and is detected by a first detection unit (torque sensor 42) that detects the torque, and a steering angle (steering angle θst) which is a rotation angle of the rotation shaft and is detected by a second detection unit (steering angle sensor 41) that detects the steering angle;

a determination unit (determination unit 32) configured to determine whether there is a non-steering operation of the steering unit based on the torque and the steering angle acquired by the acquisition unit; and

a control apparatus control unit (control apparatus control unit 33) configured to control a predetermined control apparatus mounted on the vehicle based on a determination result of the determination unit, in which

in response to a response request to a user based on a function of the control apparatus, if the non-steering operation is detected by at least one of the first detection unit and the second detection unit based on the determination result, the control apparatus control unit executes a control of the control apparatus corresponding to the response request, and

if the non-steering operation is not detected by any of the first detection unit and the second detection unit based on the determination result, the control apparatus control unit does not execute the control of the control apparatus corresponding to the response request.

According to (1), in response to the response request to the user based on the function of the control apparatus, whether there is the non-steering operation on the steering unit is determined by at least one of the first detection unit and the second detection unit, and the control apparatus is controlled based on the determination result. Accordingly, it is possible to determine whether there is the non-steering operation without providing a new component such as a measurement unit that determines whether there is the non-steering operation, in other words, using an existing component. As a result, it becomes possible to implement a switch function with excellent operability in the steering unit while avoiding an increase in cost.

(2) The control device according to (1), in which

a condition for executing the control of the control apparatus corresponding to the response request includes:

a first condition that the non-steering operation is detected by the first detector and the second detector based on the determination result; and

a second condition that the non-steering operation is detected by at least one of the first detector and the second detector based on the determination result, and

when the first condition or the second condition, which is set depending on a content of the response request, is satisfied, the circuitry executes the control of the control apparatus corresponding to the response request.

According to (2), the first condition or the second condition is set depending on the content of the response request, so that it is possible to implement a control that takes into account, for example, the safety of the vehicle when executing the control corresponding to the response request.

(3) The control device according to (2), in which

the first condition is applied to a response request involving a force control for autonomously controlling a driving force and/or a braking force, and

the second condition is applied to a response request not involving the force control.

According to (3), by applying, to the braking/driving force control, the first condition that the non-steering operation is detected by two detection units, that is, the first detection unit and the second detection unit, it becomes possible to perform a control that takes into account, for example, the safety of the vehicle.

(4) The control device according to (3), in which

the force control includes an automatic parking control of moving the vehicle to a target parking position, and

in response to the response request related to the automatic parking control, based on the determination result, when there is the response request based on the first condition, the circuitry executes the control of the control apparatus that performs the automatic parking control.

According to (4), by applying the first condition to the automatic parking control, it is possible to perform the control that takes into account the safety and the like during automatic parking.

(5) The control device according to (1) or (2), in which

when a vehicle speed of the vehicle is less than a predetermined vehicle speed, the circuitry determines whether there is the non-steering operation.

According to (5), if the vehicle speed is less than the predetermined vehicle speed, whether there is the non-steering operation is determined, in other words, if the vehicle speed is equal to or greater than the predetermined vehicle speed, whether there is the non-steering operation is not determined, so that it is possible to avoid or reduce an erroneous detection or erroneous determination of the non-steering operation due to, for example, vibrations during travelling.

(6) The control device according to (1) or (2), in which

when a steering speed of a wheel of the vehicle is less than a predetermined steering speed, the circuitry determines whether there is the non-steering operation.

According to (6), if the steering speed is less than the predetermined steering speed, whether there is the non-steering operation is determined, in other words, if the steering speed is equal to or greater than the predetermined steering speed, whether there is the non-steering operation is not determined, so that it is possible to avoid or reduce the erroneous detection or erroneous determination of the non-steering operation due to, for example, vibrations during travelling.

(7) The control device according to (1) or (2), in which

when the number of another detection by the first detector is less than a predetermined number within a predetermined time before and after a detection by the first detector, the circuitry determines whether there is the non-steering operation based on the detection by the first detector.

According to (7), if the number of other detections by the first detection unit within the predetermined time before and after the detection by the first detection unit is less than the predetermined number, whether there is the non-steering operation is determined, in other words, a case where the number of other detections is equal to or greater than the predetermined number is excluded, so that it is possible to avoid or reduce the erroneous detection or erroneous determination of the non-steering operation due to, for example, external disturbances.

(8) The control device according to (1) or (2), in which

when the number of another detection by the second detector is less than a predetermined number within a predetermined time before and after a detection by the second detector, the circuitry determines whether there is the non-steering operation based on the detection by the second detector.

According to (8), if the number of other detections by the second detection unit within the predetermined time before and after the detection by the second detection unit is less than the predetermined number, whether there is the non-steering operation is determined, in other words, a case where the number of other detections is equal to or greater than the predetermined number is excluded, so that it is possible to avoid or reduce the erroneous detection or erroneous determination of the non-steering operation due to, for example, external disturbances.

(9) The control device according to (1) or (2), in which

the non-steering operation is an operation on the steering unit that does not steer a wheel of the vehicle.

According to (9), whether there is the operation on the steering unit that does not steer the wheel of the vehicle is determined, so that it is possible to avoid confusion between an operation to steer the wheel and a response to the response request, or avoid occurrence of the erroneous detection or erroneous determination.

(10) A control device (control device 30) including:

an acquisition unit (acquisition unit 31) configured to acquire a torque (steering torque TQ) which acts on a rotation shaft (steering shaft 47) of a steering unit (steering wheel 46) of a vehicle (vehicle 1) and is detected by a first detection unit (torque sensor 42) that detects the torque, and a steering angle (steering angle θst) which is a rotation angle of the rotation shaft and is detected by a second detection unit (steering angle sensor 41) that detects the steering angle;

a determination unit (determination unit 32) configured to determine whether there is a non-steering operation of the steering unit based on the torque and the steering angle acquired by the acquisition unit; and

a control apparatus control unit (control apparatus control unit 33) configured to control a predetermined control apparatus mounted on the vehicle based on a determination result of the determination unit, in which

when the non-steering operation is detected, in response to a response request from a user based on a function of the control apparatus, by at least one of the first detection unit and the second detection unit based on the determination result, the control apparatus control unit executes a control of the control apparatus corresponding to the response request, and

when the non-steering operation is not detected by any of the first detection unit and the second detection unit based on the determination result, the control apparatus control unit does not execute the control of the control apparatus corresponding to the response request.

According to (10), in response to the response request from the user to the vehicle based on the function of the control apparatus, whether there is the non-steering operation on the steering unit is determined by at least one of the first detection unit and the second detection unit, and the control apparatus is controlled based on the determination result. Accordingly, for example, the user can issue the response request for the functioning of the control apparatus to the vehicle by performing a simple non-steering operation such as tapping the operation unit. Furthermore, it is possible to use such a simple operation to issue the response request for the functioning of the control apparatus to the vehicle, so that it is possible to implement a switch function with excellent operability while avoiding an increase in cost.

(11) The control device according to (10), in which

a condition for executing the control of the control apparatus corresponding to the response request from the user includes:

a first condition that the non-steering operation is detected by the first detector and the second detector based on the determination result; and

a second condition that the non-steering operation is detected by at least one of the first detector and the second detector based on the determination result,

the first condition is applied to a response request involving a force control of autonomously controlling a driving force and/or a braking force, and when there is the response request based on the first condition, the circuitry executes the control of the control apparatus corresponding to the response request, and

the second condition is applied to a response request not involving the force control, and when there is the response request based on the second condition, the circuitry executes the control of the control apparatus corresponding to the response request.

According to (11), the first condition or the second condition is set depending on the content of the response request, so that it is possible to implement the control that takes into account, for example, the safety of the vehicle when executing the control corresponding to the response request.

(12) A control method performed by a computer, including:

acquiring a torque (steering torque TQ) which acts on a rotation shaft (steering shaft 47) of a steering unit (steering wheel 46) of a vehicle (vehicle 1) and is detected by a first detector (torque sensor 42) that detects the torque, and a steering angle (steering angle θst) which is a rotation angle of the rotation shaft and is detected by a second detector (steering angle sensor 41) that detects the steering angle;

determining whether there is a non-steering operation of the steering unit based on the acquired torque and the acquired steering angle;

controlling a predetermined control apparatus mounted on the vehicle based on a determination result;

executing a control of the control apparatus corresponding to a response request, when the non-steering operation is detected, in response to the response request to a user based on a function of the control apparatus, by at least one of the first detector and the second detector based on the determination result; and

not executing the control of the control apparatus corresponding to the response request if the non-steering operation is not detected by any of the first detector and the second detector based on the determination result.

According to (12), in response to the response request to the user based on the function of the control apparatus, whether there is the non-steering operation on the steering unit is determined by at least one of the first detection unit and the second detection unit, and the control apparatus is controlled based on the determination result. Accordingly, it is possible to determine whether there is the non-steering operation by using an existing component, without providing a new component such as a measurement unit that determines whether there is the non-steering operation. As a result, it becomes possible to implement a switch function with excellent operability in the steering unit while avoiding an increase in cost.

(13) A control program that causes a computer to execute processes of

acquiring a torque (steering torque TQ) which acts on a rotation shaft (steering shaft 47) of a steering unit (steering wheel 46) of a vehicle (vehicle 1) and is detected by a first detector (torque sensor 42) that detects the torque, and a steering angle (steering angle θst) which is a rotation angle of the rotation shaft and is detected by a second detector (steering angle sensor 41) that detects the steering angle;

determining whether there is a non-steering operation of the steering unit based on the acquired torque and the acquired steering angle;

controlling a predetermined control apparatus mounted on the vehicle based on a determination result;

executing a control of the control apparatus corresponding to a response request, when the non-steering operation is detected, in response to the response request to a user based on a function of the control apparatus, by at least one of the first detector and the second detector based on the determination result; and

not executing the control of the control apparatus corresponding to the response request if the non-steering operation is not detected by any of the first detector and the second detector based on the determination result.

According to (13), in response to the response request to the user based on the function of the control apparatus, whether there is the non-steering operation of the steering unit is determined by at least one of the first detection unit and the second detection unit, and the control apparatus is controlled based on the determination result. Accordingly, it is possible to determine whether there is the non-steering operation by using an existing component, without providing a new component such as a measurement unit that determines whether there is the non-steering operation. As a result, it becomes possible to implement a switch function with excellent operability in the steering unit while avoiding an increase in cost.

1. A control device comprising
circuitry configured to:
acquire a torque which acts on a rotation shaft of a steering unit of a vehicle and is detected by a first detector that detects the torque, and a steering angle which is a rotation angle of the rotation shaft and is detected by a second detector that detects the steering angle;
determine whether there is a non-steering operation of the steering unit based on the torque and the acquired steering angle; and
control a predetermined control apparatus mounted on the vehicle based on a result of determination, wherein
when the non-steering operation is detected, in response to a response to a response request to a user based on a function of the control apparatus, by at least one of the first detector and the second detector based on the determination result, the circuitry executes control of the control apparatus corresponding to the response request, and
when the non-steering operation is not detected by any of the first detector and the second detector based on the determination result, the circuitry does not execute the control of the control apparatus corresponding to the response request.

2. The control device according to claim 1, wherein
a condition for executing the control of the control apparatus corresponding to the response request includes:
a first condition that the non-steering operation is detected by the first detector and the second detector based on the determination result; and
a second condition that the non-steering operation is detected by at least one of the first detector and the second detector based on the determination result, and
when the first condition or the second condition, which is set depending on a content of the response request, is satisfied, the circuitry executes the control of the control apparatus corresponding to the response request.

3. The control device according to claim 2, wherein
the first condition is applied to a response request involving force control for autonomously controlling a driving force and/or a braking force, and
the second condition is applied to a response request not involving the force control.

4. The control device according to claim 3, wherein
the force control includes automatic parking control of moving the vehicle to a target parking position, and
in response to the response request related to the automatic parking control, based on the determination result, when there is the response request based on the first condition, the circuitry executes the control of the control apparatus that performs the automatic parking control.

5. The control device according to claim 1, wherein
when a vehicle speed of the vehicle is less than a predetermined vehicle speed, the circuitry determines whether there is the non-steering operation.

6. The control device according to claim 1, wherein
when a steering speed of a wheel of the vehicle is less than a predetermined steering speed, the circuitry determines whether there is the non-steering operation.

7. The control device according to claim 1, wherein
when the number of another detection by the first detector is less than a predetermined number within a predetermined time before and after a detection by the first detector, the circuitry determines whether there is the non-steering operation based on the detection by the first detector.

8. The control device according to claim 1, wherein
when the number of another detection by the second detector is less than a predetermined number within a predetermined time before and after a detection by the second detector, the circuitry determines whether there is the non-steering operation based on the detection by the second detector.

9. The control device according to claim 1, wherein
the non-steering operation is an operation on the steering unit that does not steer a wheel of the vehicle.

10. A control method performed by a computer, comprising:
acquiring a torque which acts on a rotation shaft of a steering unit of a vehicle and is detected by a first detector that detects the torque, and a steering angle which is a rotation angle of the rotation shaft and is detected by a second detector that detects the steering angle;
determining whether there is a non-steering operation of the steering unit based on the acquired torque and the acquired steering angle;
controlling a predetermined control apparatus mounted on the vehicle based on a determination result;
executing control of the control apparatus corresponding to a response request, when the non-steering operation is detected, in response to the response request to a user based on a function of the control apparatus, by at least one of the first detector and the second detector based on the determination result; and
not executing the control of the control apparatus corresponding to the response request if the non-steering operation is not detected by any of the first detector and the second detector based on the determination result.

11. A non-transitory computer-readable storage medium storing a control program that causes a computer to execute a process, the process comprising:
acquiring a torque which acts on a rotation shaft of a steering unit of a vehicle and is detected by a first detector that detects the torque, and a steering angle which is a rotation angle of the rotation shaft and is detected by a second detector that detects the steering angle;
determining whether there is a non-steering operation of the steering unit based on the acquired torque and the acquired steering angle;
controlling a predetermined control apparatus mounted on the vehicle based on a determination result;
executing control of the control apparatus corresponding to a response request, when the non-steering operation is detected, in response to the response request to a user based on a function of the control apparatus, by at least one of the first detector and the second detector based on the determination result; and
not executing the control of the control apparatus corresponding to the response request if the non-steering operation is not detected by any of the first detector and the second detector based on the determination result.
